(19) United States
(12) Patent Application Publication
(10) Pub. No.: US 2025/0154622 A1
(43) Pub. Date: May 15, 2025

(54) RECOVERY SYSTEM OF RARE EARTH ELEMENTS BASED ON MEMBRANE APPLICATIONS

(71) Applicant: ISTANBUL TEKNIK UNIVERSITESI, Istanbul (TR)

(72) Inventors: Borte KOSE MUTLU, Istanbul (TR); Ayse YUKSEKDAG, Istanbul (TR); Ismail KOYUNCU, Istanbul (TR); Mark Robert WIESNER, Durham, NC (US)

(73) Assignee: ISTANBUL TEKNIK UNIVERSITESI, Istanbul (TR)

(21) Appl. No.: 18/837,625

(22) PCT Filed: Feb. 10, 2023
(86) PCT No.: PCT/TR2023/050123

§ 371 Date: Aug. 12, 2024

(30) Foreign Application Priority Data
Feb. 10, 2022 (TR) 2022/001725

(51) Int. Cl. C22B 3/02; B01D 11/02; B01D 61/02; B01D 61/14; B01D 61/58; C22B 3/22; C22B 7/00; C22B 59/00

(52) U.S. Cl. CPC C22B 3/02; B01D 11/0288; B01D 61/58; C22B 3/22; C22B 7/007; C22B 59/00; B01D 61/027; B01D 61/147; B01D 2313/243; B01D 2317/02

(57) ABSTRACT

A rare earth element recovery system and method are provided. The system includes a heated water bath, a jacketed leaching reactor connected to the heated water bath, a leaching pump connected to the jacketed leaching reactor, a concentrated acidic leaching peristaltic pump for transferring a concentrated acidic leach in connection with a concentrated acidic leaching chamber, a membrane contactor connected to the concentrated acidic leaching peristaltic pump, a stripping phase leaching chamber, a stripping phase peristaltic pump connected to the stripping phase leaching chamber, a paddle mixer, a microfiltration unit connected to the leaching pump, a high pressure pump connected to the microfiltration unit, and a nanofiltration unit.

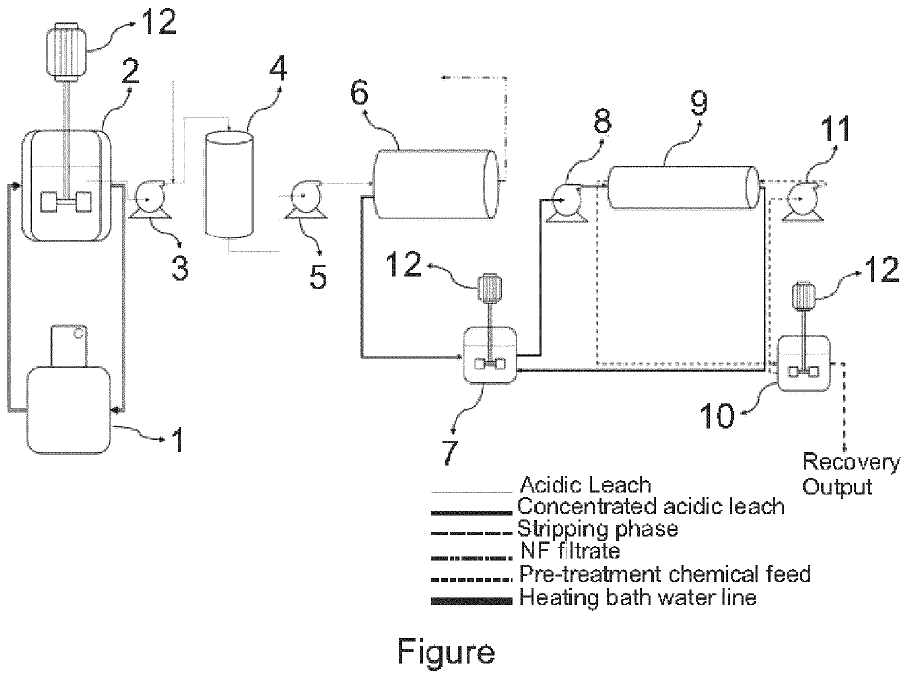

### CROSS REFERENCE TO THE RELATED APPLICATIONS

This application is the national phase entry of International Application No. PCT/TR2023/050123, filed on Feb. 10, 2023, which is based upon and claims priority to Turkish Patent Application No. 2022/001725, filed on Feb. 10, 2022, the entire contents of which are incorporated herein by reference.

### TECHNICAL FIELD

The invention relates to a system comprising a nanofiltration membrane for pre-concentration of rare earth elements prior to solvent extraction in a process for their recovery.

### BACKGROUND

In the 1940s, solvent extraction method, which was used especially in the refining of uranium ore, is now frequently used in the recovery processes of various rare earth elements. Today, most of the metals in the periodic table can be recovered by solvent extraction method. These metals are alkali metals (Rb, Cs), alkaline earth metals (Be, Mg, Ca), transition metals (Sc, Ti, V, Cr, Mn, Fe, Co, Co, Ni, Cu, Zn, Cd, Hg), rare metals (Zr, Hf, Nb, Ta, Mo, W, Tc, Re, Al, Ga, In, Tl, Si, Ge, Sn, As, Bi, Se, Te), noble metals (Au, Ag, Ru, Ir, Pt, Pd, Rh), actinides (U, Th), lanthanides [1].

There are two phases in the solvent extraction method. It contains two components that are insoluble in each other. In the recovery processes of rare earth elements, the first phase is the acidic leaching phase and the second phase is the phase in which the carrier agent is prepared by diluting in an organic solvent and is called the organic phase. After mixing these two phases, the target elements are transferred from the acidic feed phase to the organic phase. This process is called solvent extraction. In order for the elements transferred to the organic phase to pass back to the acidic phase, a second process called stripping is applied. The charged organic phase containing the target elements is mixed with an acid solution containing no elements, which is called the stripping phase. Thus, at the end of the second stage, the elements in the acidic leaching solution are selectively transferred to the stripping solution.

With the development of the industry, membrane-containing units have started to be used in the recovery processes of rare earth metals from industrial wastes. Ion exchangers, liquid-liquid extraction, impregnated resins and liquid membranes are examples of these units. Membranes are also used in solvent extraction processes. In order to separate the organic phase from the aqueous phase more easily and also to minimise the loss of organic phase, hydrophobic polymeric membranes that are afraid of water are integrated into the processes. Liquid membrane or supported liquid membranes are example configurations for membrane solvent extraction. In the supported liquid membrane, the pores of the hydrophobic polymeric membrane are saturated with the organic phase in question and it is ensured to remain in the pores by capillary forces. Therefore, the volume of organic phase used in the supported liquid membrane is quite low compared to classical solvent extraction. Since one surface of the supported liquid membrane is in contact with acidic leaching and the other surface is in contact with the stripping phase, extraction and stripping processes are carried out simultaneously.

Since pre-concentration is not performed in the studies in the known state of the technique, the acidic leaching volumes sent to solvent extraction are quite high, which leads to excess capacity required for solvent extraction.

In the United States patent document numbered US2021388464A1 in the known state of the art, it is mentioned that more than one ultrafiltration, nanofiltration and/or reverse osmosis membranes are used for the recovery of precious earth metals by concentrating the metals in the recovery of precious earth metals.

In the United States patent document US2015307965A1, which is in the known state of the art, a process using extraction and membrane for the recovery of rare earth elements is mentioned.

However, in the systems included in the exemplary patent documents, there is no method of concentrating the target elements before the supported liquid membranes and then subjecting them to the extraction process using the supported liquid membrane.

In the known state of the art, it is known that supported liquid membranes are used in extraction processes in the process of rare earth elements recovery. However, the pre-concentration process to reduce the volume of the extraction process and the nanofiltration unit for this process is not included in the known state of the art. Therefore, the invention system needed to be developed.

### SUMMARY

The object of the present invention is to realise a system comprising a nanofiltration unit prior to a supported liquid membrane unit for pre-concentration.

Another aim of the present invention is to realise a system that enables the reduction of the acidic leaching volume with its nanofiltration unit.

### BRIEF DESCRIPTION OF THE DRAWINGS

The recovery system of rare earth elements based on the developed membrane applications realised to achieve the objects of the present invention is shown in the accompanying figures.

These figures;

Figure is a detailed flow chart of the rare earth element recovery system based on membrane applications.

The parts in the figure are numbered one by one and the equivalents of these numbers are given below.
1. Heated water bath
2. Jacketed leaching reactor
3. Leaching pump
4. Microfiltration unit
5. High pressure pump
6. Nanofiltration unit
7. Concentrated acidic leaching chamber
8. Concentrated acidic leaching peristaltic pump
9. Membrane contactor
10. Stripping phase leaching chamber
11. Stripping phase peristaltic pump
12. Pedal mixer

### DETAILED DESCRIPTION OF THE EMBODIMENTS

The rare earth element recovery system based on membrane applications comprises the following;
a heated water bath (1) for carrying out the leaching process at constant temperature,
jacketed leaching reactor (2) connected to a heated water bath (1), which allows the leaching of secondary sources in the solid phase (magnets, fluorescent lamps, catalysts and rechargeable batteries, etc.) under constant temperature and pH,
a leaching pump (3) connected to the jacketed leaching reactor (2), used for the transfer of secondary sources in the solid phase from the jacketed leaching reactor (2),
a microfiltration unit (4) connected to the leaching pump (3), which provides pre-treatment of secondary sources in the solid phase to remove hydroxide floc precipitates that may form after pH treatment and particulate matter from acidic leaching,
a high pressure pump (5) connected to the microfiltration unit (4), for transferring the acidic leach treated by the microfiltration unit (4),
a nanofiltration unit (6) including nanofiltration membranes for pre-concentration and pressure vessel and inlet and outlet components in connection with a high pressure pump (5),
concentrated acidic leaching chamber (7) connected to the nanofiltration unit (6), to which the concentrated acidic leach is transferred,
a concentrated acidic leaching peristaltic pump (8) for transferring the concentrated acidic leach in connection with the concentrated acidic leaching chamber (7),
a membrane contactor (9) connected to the concentrated acidic leaching peristaltic pump (8), which ensures that the concentrated acidic phase, the stripping phase and the membrane material saturated with the organic phase are in contact,
a stripping phase leaching chamber (10) for the stripping phase, connected to the membrane contactor (9),
the stripping phase peristaltic pump (11) connected to the stripping phase leaching chamber (10), used to feed the concentrated stripping phase in membrane solvent extraction to the membrane contactor (9) at a given speed and flow rate,
a paddle mixer (12) used to ensure mixing of the jacketed leaching reactor (2), the concentrated acidic leaching chamber (7) and the stripping phase leaching chamber (10), such as in a full-mix reactor.

The recovery method of rare earth elements based on membrane applications comprises the following process steps;
Leaching of secondary sources in the solid phase in the jacketed leaching reactor (2) by stirring with the help of a stirrer under constant temperature and pH with a heated water bath (1),
Transfer of the obtained leaching to the microfiltration unit (4) by leach pump (3),
Pre-treatment in the microfiltration unit (4) operated under vacuum pressure to remove hydroxide floc solutions and particulate matter from acidic leaching that may be formed after pH increase in the acidic leaching solution,
Transfer of the pretreated acidic leaching solution obtained as a result of the pretreatment process to the nanofiltration unit (6) by high pressure pump (5),
Pre-concentration of acidic leaching solution in a thin film coated nanofiltration unit (6) under high pressure (10-20 bar) and low pH (about 1-1.5) conditions,
Storage of the concentrated acidic leaching phase obtained from the nanofiltration unit (6) in the concentrated acidic leaching chamber (7),
Transfer of the concentrated acidic leaching phase to the membrane contactor unit (9) at a certain speed and flow rate by the concentrated acidic leaching pump (8),
Performing the extraction process by contact of concentrated acidic feed leaching and stripping phase solution using flat sheet supported liquid membrane saturated with organic phase in membrane contactor unit (9),
Transfer of the concentrated stripping phase after extraction from the membrane contactor unit (9) to the stripping phase leaching chamber (10),
The stripping phase in the stripping phase leaching chamber (10) is transferred to the membrane contactor unit (9) by the stripping phase peristaltic pump (11) at a certain flow rate and reused,
Storage of the concentrated acidic leaching phase obtained from the membrane contactor unit (9) in the concentrated acidic leaching chamber (7),
Continuous mixing of the jacketed leaching reactor (2), concentrated acidic leaching chamber (7), stripping phase leaching chamber (11) by the paddle mixer (12).

With the present invention, smaller capacities are achieved by reducing the volume to be entered into the membrane solvent extraction. For this purpose, pre-concentration process is applied before membrane solvent extraction unlike the existing studies. Thus, the volume is reduced and the rare earth elements in the acidic leaching solution are concentrated. The nanofiltration unit (6) does not pass divalent and polyvalent ions, while it passes monovalent ions (Na+, OH−) from sodium hydroxide used in pH adjustment. Thus, in the concentrated acidic leaching phase to be obtained at the end of the nanofiltration process, both the concentrations of rare earth elements will increase and the volume will decrease by approximately 60%-70%. Since the nanofiltration filtrate contains a significant amount of acid, it will be possible to recover acid from this phase and transfer it to acidic leaching. Since the nanofiltration process cannot retain monovalent hydrogen ions (H+), there will be no significant pH change in the filtrate and concentrate phases compared to the inlet phase.

Unlike the existing studies, the capacity required for membrane solvent extraction was reduced by using the nanofiltration unit (6) to perform the pre-concentration process before the supported liquid membrane unit (9), which performs the solvent extraction process, and has been a residual solution to the low concentrations of rare earth elements observed in acidic leaching.

Also improvements obtained with the present invention;
Acidic leaching volume is reduced by nanofiltration process.
The concentrations of rare earth elements in the concentrated acidic leaching phase are increased compared to crude acidic leaching.
The capacity required for membrane solvent extraction is reduced due to the lower volumes of concentrated acidic leach phase.
By using the supported liquid membrane in the solvent extraction process instead of classical solvent extraction, the required organic phase volume is reduced.
Acid recovery from nanofiltration filtrate can be realised.

Pre-treatment by microfiltration is frequently used to remove particulate matter from acidic leaching. The methods used are filter press or vacuum filtration. In the present invention, a microfiltration system operated under vacuum pressure is used for the removal of hydroxide floc precipitates that may form after pH increase and particulate matter from acidic leaching. The pre-treatment process is important in the present invention since suspended and colloidal substances should be removed before the nanofiltration process.

The acidic leaching solution subjected to pre-treatment in the microfiltration unit (4) is transferred to the nanofiltration unit (6) with thin film coating and concentrated with high pressure (10-20 bar). Here, the choice of polymer-based nanofiltration that can operate under low pH (about 1-1.5) conditions is very important. The nanofiltration process should be operated with a filtrate recovery of approximately 60%-70% for the predicted volume reduction.

For the flat sheet supported liquid membrane, a glass reactor is required where both acidic phases are in contact with one side of the polymeric membrane. For hollow fibre supported liquid membrane, a membrane contactor (9) should be used. Both acidic phases (feed acidic leaching and stripping) must be mixed throughout the reaction to ensure fully mixed reactor conditions. The membrane material to be used for the supported liquid membrane should be PVDF (polyvinylidenefluoride) or PP (polypropylene). The organic phase is prepared by diluting and mixing a carrier agent (D2EHPA, TBP, Cyanex 272, 18-Crown-6, etc.) with an organic solvent (kerosene, octanol, etc.) at a concentration of 5%-15%. This solution should be prepared in glass reactors. After the prepared organic phase is filtered through the polymeric membrane at least once, the membrane should be kept in the same solution for at least one night. Before the reaction is started, the excess organic phase remaining on the membrane surface must be removed. Otherwise, the excess organic phase dispersively disperses into the acidic leaching solution and performs extraction here. However, since it is not in contact with the stripping phase, it reduces the efficiency of net transport. 4-7 M mineral acid solution should be used as stripping phase. After the optimum reaction time, the membranes should be regenerated again with the organic phase.

### REFERENCES

[1] Pinar SUMER, Düşük Konsantrasyonlu Çözeltilerden Solvent Ekstraksiyon Yöntemiyle Rodyum Altin ve Gümüş Geri Kazanimi, MSC Thesis, Istanbul Technical University, September 2009.

What is claimed is:

1. A rare earth element recovery system based on membrane applications comprising:
a heated water bath used to carry out a leaching process at a constant temperature,
a jacketed leaching reactor connected to the heated water bath and allowing a leaching of secondary sources in a solid phase under the constant temperature and a constant pH,
a leaching pump connected to the jacketed leaching reactor and used for a transfer of the secondary sources in the solid phase from the jacketed leaching reactor,
a concentrated acidic leaching peristaltic pump for transferring a concentrated acidic leach in connection with a concentrated acidic leaching chamber,
a membrane contactor connected to the concentrated acidic leaching peristaltic pump and ensuring a concentrated acidic phase, a stripping phase and a membrane material saturated with an organic phase to be in contact,
a stripping phase leaching chamber for the stripping phase, connected to the membrane contactor,
a stripping phase peristaltic pump connected to the stripping phase leaching chamber, and used to transfer the stripping phase concentrated by a membrane solvent extraction to the membrane contactor,
a paddle mixer used to ensure a mixing of the jacketed leaching reactor, the concentrated acidic leaching chamber and the stripping phase leaching chamber, wherein the paddle mixer is a full-mix reactor,
a microfiltration unit connected to the leaching pump and configured to pre-treat the secondary sources in the solid phase to remove hydroxide floc precipitates formed after a pH treatment and particulate matters from an acidic leaching,
a high pressure pump connected to the microfiltration unit, and configured for transferring an acidic leach treated by the microfiltration unit,
a nanofiltration unit comprising nanofiltration membranes, pressure vessel and inlet and outlet components for a pre-concentration in connection with the high pressure pump,
the concentrated acidic leaching chamber connected to the nanofiltration unit, wherein the concentrated acidic leach is transferred to the concentrated acidic leaching chamber.

2. The rare earth element recovery system according to claim 1, wherein the membrane contactor comprises a hollow fibre supported liquid polymer based membrane.

3. A method for a recovery of rare earth elements based on membrane applications, comprising the following process steps:
leaching secondary sources in a solid phase in a jacketed leaching reactor by stirring with a stirrer under a constant temperature and a constant pH with a heated water bath,
transferring an obtained leach to a microfiltration unit with a leaching pump,
pre-treating an acidic leaching solution in the microfiltration unit operated by a vacuum pressure, to remove hydroxide floc solutions and particulate matters from an acidic leaching, wherein the hydroxide floc solutions and the particulate matters are formed after a pH increase in the acidic leaching solution,
transferring a pre-treated acidic leaching solution obtained as a result of a pre-treatment process to a nanofiltration unit by a high pressure pump,
pre-concentrating the pre-treated acidic leaching solution in a thin film coated nanofiltration unit under a pressure of 10 bar-20 bar and a pH of 1-1.5,
storing a concentrated acidic leaching phase obtained from the nanofiltration unit in a concentrated acidic leaching chamber,
transferring an acidic leaching phase concentrated by a concentrated acidic leaching pump to a membrane contactor unit,
performing an extraction process by a contact of a concentrated acidic feed leaching and a stripping phase solution using a flat sheet supported liquid membrane saturated with an organic phase in the membrane contactor unit,
transferring a concentrated stripping phase after an extraction from the membrane contactor unit to a stripping phase leaching chamber,
re-using the concentrated stripping phase in the stripping phase leaching chamber by transferring the concentrated stripping phase to the membrane contactor unit with a stripping phase peristaltic pump,
storing a concentrated acidic leaching phase obtained from the membrane contactor unit in the concentrated acidic leaching chamber,
continuous mixing the jacketed leaching reactor, the concentrated acidic leaching chamber, and the stripping phase leaching chamber by a paddle mixer.
